(19) United States
(12) Patent Application Publication
(10) Pub. No.: US 2011/0108491 A1
(43) Pub. Date: May 12, 2011

(54) DESALINATION USING SUPERCRITICAL WATER AND SPIRAL SEPARATION

(75) Inventors: Meng H. Lean, Santa Clara, CA (US); Jeonggi Seo, Albany, CA (US); Armin R. Volkel, Mountain View, CA (US)

(73) Assignee: PALO ALTO RESEARCH CENTER INCORPORATED, Palo Alto, CA (US)

(21) Appl. No.: 12/615,663

(22) Filed: Nov. 10, 2009

(51) Int. Cl. C02F 1/52

(52) U.S. Cl. 210/737; 210/512.1; 210/179

(57) ABSTRACT

The present application relates to systems and methods for the desalination of water. The systems and methods receive source water containing particles therein from a source of water such as, for example, the ocean. The source water may be pre-treated to remove suspensions and/or sub-micron organics in the source water. The source water is used to generate supercritical water having a pressure and temperature above a critical pressure and a critical temperature, respectively. The supercritical water is run through a spiral separator to generate effluent water and waste water containing aggregated particles therein. Energy may be recovered from the effluent water and used to generate additional supercritical water.

### INCORPORATION BY REFERENCE

The disclosures of U.S. patent application Ser. No. 11/936,729 (U.S. Publication No. 2009/0114607) for “FLUIDIC DEVICE AND METHOD FOR SEPARATION OF NEUTRALLY BUOYANT PARTICLES,” by Lean et al., filed Nov. 7, 2007; U.S. patent application Ser. No. 11/606,460 (U.S. Publication No. 2008/0128331) for “PARTICLE SEPARATION AND CONCENTRATION SYSTEM”, by Lean et al.; U.S. patent application Ser. No. 11/936,753 (U.S. Publication No. 2009/0114601) for DEVICE AND METHOD FOR DYNAMIC PROCESSING IN WATER PURIFICATION″, by Lean et al.; U.S. patent application Ser. No. 11/606,458 (U.S. Publication No. 2009/0050538) for “SERPENTINE STRUCTURES FOR CONTINUOUS FLOW PARTICLE SEPARATIONS”, by Lean et al.; U.S. patent application Ser. No. 11/725,358 (U.S. Publication No. 2008/0230458) for “VORTEX STRUCTURE FOR HIGH THROUGHPUT CONTINUOUS FLOW SEPARATION”, by Lean et al.; and U.S. Pat. No. 7,186,345 for “SYSTEMS FOR WATER PURIFICATION THROUGH SUPERCRITICAL OXIDATION,” by Lee et al., filed May 6, 2004, are each hereby incorporated herein by reference in their entireties.

### BACKGROUND

The exemplary embodiments of the present application relate generally to methods and systems for purifying water. They find particular application in conjunction with water desalination, and will be described with particular reference thereto. However, it is to be appreciated that the exemplary embodiments are also amenable to other like applications.

Conventional water desalination is based on temperature or pressure. With respect to sea water, there are generally two methods used to desalinate the water: thermal distillation (e.g. multi-stage flash distillation) and reverse osmosis. Drawbacks of these processes include high energy costs for flash distillation and the requirement of frequent back flush of the reverse osmosis (RO) membrane as effluent recovery efficiency drops rapidly with usage. With respect to brackish water, Electro-Deionization (ED) is another alternative. Under a system for ED, reduced conductivity of brackish water relative to sea water allows for efficient operation with lower Joule heating.

Recent developments in both energy and pressure recovery have lowered the energy cost of water desalination to 1.7 kWh/m³ (or 6.46 W/gph). Notwithstanding these improvements, however, the energy cost of water desalination is still comparatively high compared to the energy cost of conventional water treatment. Namely, the energy cost of conventional water treatment is 2-4 W/gph. Accordingly, there exists a need for systems and methods for water desalination that have an energy cost more in line with that of conventional water treatment systems.

Energy costs aside, some desalination systems produce environmentally harmful waste water that can be difficult to dispose of. Reverse osmosis, for example, produces brine water as a byproduct of the desalination process. Brine water, because of its high concentration of salt, is generally toxic to both plants and animals. Moreover, because the salt is dissolved within the water, it is generally difficult to remove the salt from the water. Other desalination systems, in addition to, or in alternative to, producing brine water use chemicals to advance the desalination process, whereby waste water (such as brine water) containing such chemicals may be produced. Naturally, the chemicals, similar to a high concentration of salt, may be toxic to plants and animals. Accordingly, it would be advantageous to have systems and methods for water desalination that do not produce environmentally harmful waste water.

Notwithstanding the potential environmental impact of chemicals, discussed above, chemicals also add to the operating expense of a water desalination system. Accordingly, it would be advantageous to have systems and methods for water desalination that do not require chemicals.

Additionally, the waste water from most desalination systems contains high concentrations of salt. As the skilled artisan will appreciate, salt has value in the chemical industry, whereby it could be sold to offset the cost of operating a desalination system. However, one problem thus far has been that the cost of separating the salt from the waste water has proven to be uneconomical. Additionally, even if the salt is separated from the waste water, it contains a mixture of various types of salt. The chemical industry will generally require concentrated amounts of certain types of salts as opposed to a hodgepodge of different salts. Accordingly, it would be advantageous to have a desalination system that allows for the economic recovery of salt from waste water, and further allows the ratio of different types of salt to be adjusted.

From a maintenance standpoint, some desalination systems have to contend with scale build-up that needs to be periodically cleaned for efficient operation. Similarly, in the case of reverse osmosis, the RO membrane requires frequent back flush to clean the membrane. Naturally, periodic cleaning factors into the cost of producing desalinated water, whereby it would be advantageous to have a system that doesn't require frequent cleaning, or has an automated mechanism to clean itself.

Beyond maintenance, zero liquid discharge (ZLD) targets seek to extract 100% of the salt from water. However, some desalination systems, such as reverse osmosis, are directly salt concentration dependent. That is to say, the efficiency of desalination reduces as the salt concentration increases. Accordingly, it would be advantageous to have a desalination system that is not dependent on the concentration of salt dissolved within the water.

The present application contemplates new and improved systems and/or methods which may be employed to mitigate the above-referenced problems and others.

### BRIEF DESCRIPTION

According to one aspect of the present application, a method for treatment of water is provided. The method includes receiving source water having particles therein and generating supercritical water from the source water. The method further includes separating the supercritical water into effluent water and waste water having aggregated particles. The supercritical water is separated using a spiral separator.

According to another aspect of the present application, a system for the treatment of water is provided. The system includes an inlet operative to receive source water having particles therein. The system further includes a supercritical water generator operative to generate super critical water from the source water and a spiral separator operative to separate the supercritical water into effluent water and waste water having aggregated particles therein. The system further includes an outlet operative to provide a path for the effluent water.

According to yet another aspect of the present application, a system for separation of particles from supercritical water is provided. The system includes an inlet to receive at least a portion of the supercritical water containing the particles. The system further includes a spiral channel within which the supercritical water flows in a manner such that the particles flow in a tubular band offset from a center of the channel. The channel is pressurized to at least 22.1 MPa and the supercritical water is heated to at least 647° K. The system further includes a first outlet for the supercritical water within which the tubular band flows and a second outlet for the remaining supercritical water.

### BRIEF DESCRIPTION OF THE DRAWINGS

FIG. 1 is graph illustrating the solubility of various salts in supercritical water as a function of temperature;

FIG. 2 is a representation of a particle flowing through a channel of a spiral separator and forces acting thereon;

FIG. 3 is an illustration of a channel of a spiral separator;

FIG. 4 is an exemplary method for desalinating water;

FIG. 5 is a graph illustrating the energy requirements of various desalination processes as a function of energy recovery;

FIG. 6 is an exemplary system for desalinating water.

FIG. 7 is a schematic view of a pressure exchange, which may be used in the preset application; and

FIG. 8 is an alternative embodiment of the preset system.

### DETAILED DESCRIPTION

The exemplary embodiments use a spiral separator configured to exploit the properties of supercritical water for water desalination. As will be discussed below, by first converting source water to supercritical water, particles disposed therein (e.g., salt) can be more easily separated using a spiral separator.

Supercritical water is achieved at a critical temperature T_{c}=647° K or greater and a critical pressure p_{c}=22.1 MPa or greater. Compared to water at ambient conditions, supercritical water exhibits properties that more readily facilitate desalination. Among these properties, supercritical water has a viscosity of approximately 1/100 that of normal water. The two orders of magnitude reduction allows fluid to move much more rapidly through a device, whereby the flow rates through the device for a given pressure gradient are approximately 100 times higher. This advantageously allows the device to be reduced in size. Another property of supercritical water, although counter-intuitive, is that the solubility of inorganic salts in supercritical water is basically zero. For example, it drops from 40%/weight at 300° C. to 100 ppm at 450° C.

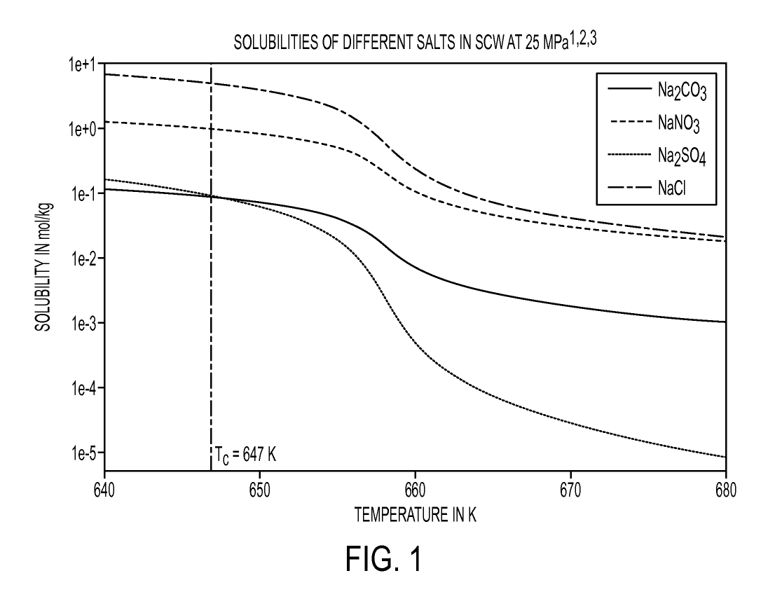

With reference to FIG. 1, a graph of the solubility of various salts as a function of temperature is illustrated. As the temperature increases, the solubility of salts in supercritical water decreases, whereby the salts more rapidly precipitate out of the water. Additionally, solubility varies depending upon the type of salt. These disparities between the solubility of different types of salt can be exploited to separate the salts on the basis of type, or adjust the ratio of different types of salt suspended in the supercritical water. Notwithstanding that the pressure is fixed at a constant level (e.g., 25 MPa), it should be appreciated that a graph of the solubility of various salts as a function of pressure would exhibit similar properties as the graph of the solubility of various salts as a function of temperature. Thus, it should be appreciated that both pressure and temperature play a role in the solubility of salts in supercritical water.

After water has reached a supercritical state, a spiral separator is used to separate the salts which precipitate out of the supercritical water. The spiral separator to which the exemplary embodiments relate is configured in accordance with the spiral separators such as discussed in various ones of the incorporated references, such spiral separators being modified to operate with supercritical water. As should be appreciated, this entails modifying the spiral separator to handle the increased pressure and temperatures necessary for supercritical water. One option for achieving this is placing a spiral separator into a standard Conflat flange system. As the skilled artisan will appreciate, such a system can easily handle the temperatures and pressures of supercritical water. The modified spiral separator, in one embodiment, may be made out of carbon reinforced steel, although other materials which are able to withstand the heat and pressure may also be used.

Additionally, because supercritical water has a viscosity 1/100 that of normal water, the actual volume for the modified spiral separator can advantageously be scaled down by at least a factor of 100 relative to the spiral separator incorporated herein by reference for a given flow rate.

In one embodiment, the spiral separator uses a curved channel of a spiral device to introduce a centrifugal force upon entrained in a fluid, e.g., water, to facilitate improved separation of such particles from the fluid. As these particles flow through the channel, a tubular pinch effect causes the particles to flow in a tubular band. The introduced centrifugal force perturbs the tubular band (e.g. forces the tubular band to flow in a manner offset from a center of the channel), resulting in an asymmetric inertial migration of the band toward the inner wall of the channel. This force balance allows for focusing and compaction of suspended particulates into a narrow band for extraction. The separation principle contemplated herein implements a balance of the centrifugal and fluidic forces to achieve asymmetric inertial equilibrium near the inner sidewall. Angled impingement of the inlet stream towards the inner wall also allow for earlier band formation due to a Coanda effect where wall friction is used to attach the impinging flow.

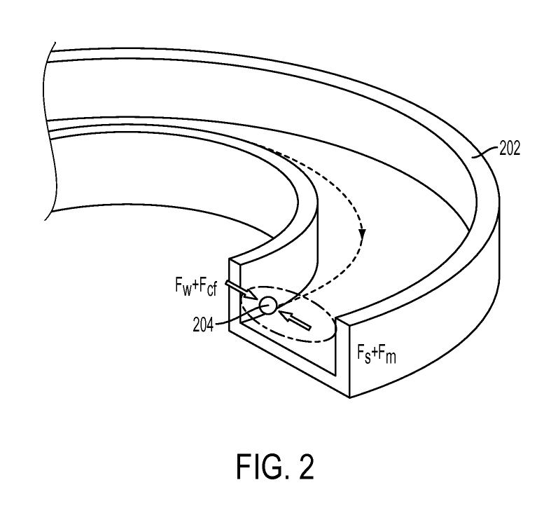

With reference to FIG. 2, a curved channel 202 (e.g., a curved portion of a spiral) having a particle 204 flowing there through is shown. As can be seen, asymmetric tubular pinch effects in the channel—created by various forces—are shown. The forces include a lift force F_{w} from the inner wall, a Saffman force Fₛ, Magnus forces Fₘ and a centrifugal force F_{cf}. It should be appreciated that the centrifugal force F_{cf} is generated as a function of the radius of curvature of the channel. In this regard, this added centrifugal force F_{cf} induces the slow secondary flow or Dean vortex flow (shown by the dashed arrows) which perturbs the symmetry of the regular tubular pinch effect. Particles are concentrated in the inner equilibrium of the velocity contour (shown in the dashed ellipses).

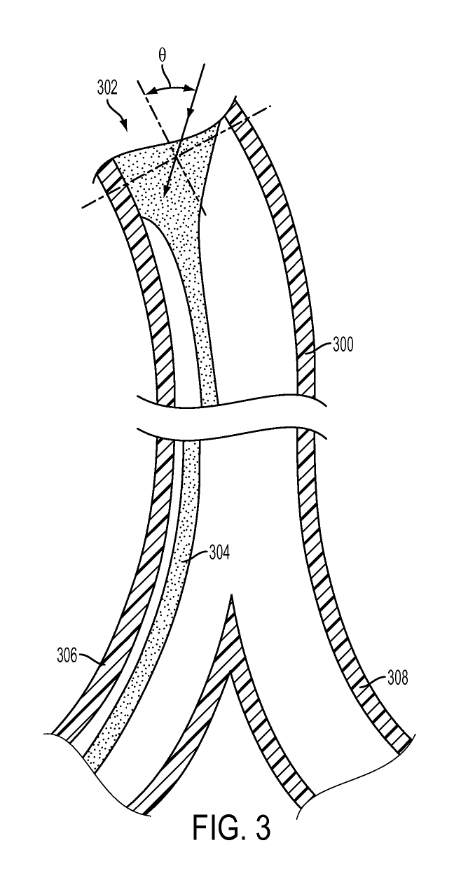

With reference to FIG. 3, a channel 300 has an inlet 302 wherein the inlet stream is angled toward the inner wall by an angle θ. It should be appreciated that inlet 302 may optionally be designed to provide for an angled or inclined entry of fluid to the spiral separator 300 to facilitate quicker formation of the tubular band along an inner wall of the spiral channel. This is the result of the Coanda effect where wall friction is used to attach the impinging flow. The tubular band 304 is thus formed earlier for egress out of the outlet 306. Band 304 includes, for example, material being removed from the stream input at inlet 302, such as salt. Of course, the second outlet 308 for the remaining fluid in which the band 304 does not flow is also shown. It should be understood that the inlet angle may be realized using any suitable mechanism or technique. Also, the spiral separator may have a single spiral structure or multiple spiral structures.

Referring still to FIG. 3, according to the presently described embodiments, the noted lateral forces across the spiral channel geometry transform a relatively homogeneous distribution of particles at the inlet 302 into an ordered band at the outlet 304. After spiral circulation, particles are collected at an inside outlet 306 and the effluent (water) are collected at an outside outlet 308.

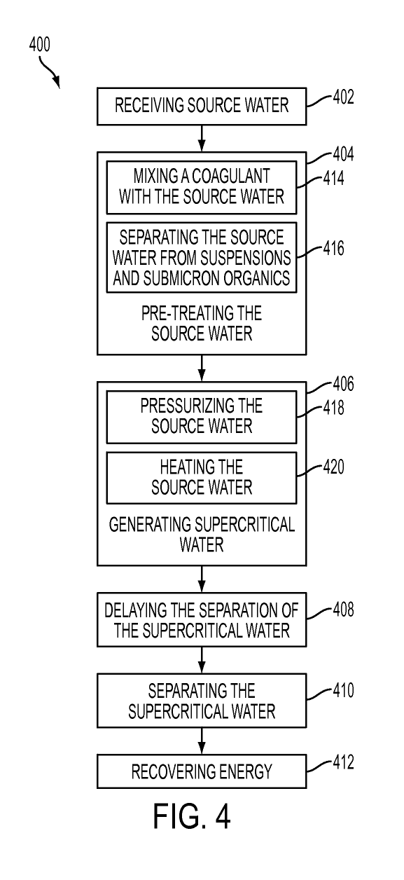

With reference to FIG. 4, an exemplary method 400 for water desalination is illustrated. The exemplary method 400 includes receiving source water (at 402), optionally pre-treating the source water (at 404), generating supercritical water from the source water (at 406), optionally delaying the separation of the supercritical water (at 408), separating the supercritical water which results in generating a stream of sterile potable water and a waste stream (at 410), and optionally recovering energy from a portion of the supercritical water (at 412). Pre-treating the source water (at 404) includes optionally mixing a coagulant with the source water (at 414) and separating the source water from suspensions and submicron organics (at 416). Generating supercritical water (at 406) includes pressurizing the source water (at 418) and heating the source water (at 420).

As mentioned, an exemplary method 400 begins by receiving source water (at 402). Source water, as its name would imply, merely refers to water from a source, such as the ocean or an aquifer. Naturally, as the exemplary methods and systems of the present application are directed towards water desalination, the source water preferably contains salts therein. However, the skilled artisan will appreciate that the teachings of the present application is equally amenable to source water containing particles other than salt, whereby the exemplary methods and systems may be used more generally for water purification. In fact, notwithstanding that salt generally has density greater than that of water, the spiral separator discussed above allows the removal of neutrally buoyant particles.

After receiving source water (at 402), the source water is, again, optionally pre-treated (at 404). The goal of pre-treatment (at 402) is to remove suspensions and/or sub-micron organics contained within the source water. Sub-micron organics include, for example, total organic carbon (TOC) and some viruses and toxins. Pretreatment (402) includes optionally mixing a coagulant with the source water (at 414) and separating the source water from suspensions and submicron organics (at 416). The coagulant causes suspended particles disposed within the source water to clump together. Naturally, the larger the suspensions within the source water, the easier it is to separate the suspensions from the source water. After the coagulant is mixed in the source water (at 414), assuming a coagulant is used, the source water is separated from the suspensions therein (at 416). Essentially, the loose particles floating around in the water are removed (e.g., algae). Preferably, this is accomplished through the use of a spiral separator capable of removing neutrally buoyant particles, such as the spiral separator of U.S. patent application Ser. No. 11/936,729, incorporated herein by reference. Thus, pre-treatment (at 404) serves to produce a higher quality water for desalination, which advantageously reduces the energy requirements for producing the supercritical water because superfluous material is not heated (when generating supercritical water).

Regardless of whether or not there is pre-treatment of the source water (at 504), supercritical water is generated from the source water (at 406) next. The generation of supercritical water (at 406) includes pressurizing the source water (at 418) and heating the source water (at 420). As discussed above, the source water needs to be pressurized beyond the critical pressure p_{c} of 22.1 MPa. Additionally, the source water needs to be heated beyond the critical temperature T_{c} of 647° K. The result of heating and pressurizing the water beyond critical temperature T_{c} and the critical pressure p_{c}, respectively, is that salt disposed within the water begins to precipitate out of the water.

As discussed in connection with FIG. 1, the amount of precipitation varies for different types of salts based upon the temperature and pressure of the supercritical water. Accordingly, by varying the pressure and temperature of the supercritical water, one can control the ratio of different types of salts suspended within the supercritical water. One can, for example, adjust the ratio so that the salt suspended within the water is predominantly of a single type of salt. For example, FIG. 1 shows solubility curves for different salts at a given pressure of 25 MPa and a range of temperatures: 640° K-680° K. at 647° K, the solubility of NaCl, NaNO3, and Na2SO4 are 10, 1, and 0.1 moles/kg, respectively. Depending on the abundance of these three salts, holding the sample at this temperature will provide the thresholds of solubility which results in dissolved salts in the proportion of 1:10:100. All salts above this solubility limit will precipitate out. Moving to a temperature of 680° K, the solubility of NaCl and NaNo3 is almost identical but that for Na2SO4 is now 1000× lower. The dissolved proportions are now 1:1:1000 with the rest as precipitates. Adjusting temperature, and based on the amount of the raw feed water, allows selective removal of salts in higher or lower proportions. Thus the present concepts permit the precipitation of selected salts in a single or in multiple consecutive steps.

Advantageously, one may use this to extract, and sell, salt particles from the supercritical water which have value to the chemical industry. As hinted at above, the extracted salt can help offset the cost of the desalination. As should be appreciated, because the salt is suspended, as opposed to dissolved, in the water it is relatively easy to extract.

Beyond facilitating extraction of salt, the heat and pressure of the supercritical water also advantageously denatures and oxidizes any organic materials disposed within the supercritical water, thereby making the water free of any potential harmful biological entities (such as e.g. potential biological warfare agents) which cannot be filtered out in the optional pre-treatment (at 404). While the supercritical water will generally have enough oxygen to oxidize the organic matter present, in situations where the oxygen content of the supercritical water is low, oxygen may be injected into the supercritical water. For more details pertaining to one process for denaturing of organic contaminants in water through the use of supercritical ater and oxygen, see U.S. Pat. No. 7,186,345, incorporated herein by reference.

Assuming supercritical water has been generated from the source water (at 406), the supercritical water may optionally be delayed before sending it through the separator to allow the salt dissolved within the supercritical water to precipitate out (at 408). Delaying the supercritical water (at 406) advantageously allows the salts dissolved therein more time to precipitate, and in turn, allows salt crystals that precipitate out of the supercritical water to grow larger in size. Naturally, the larger the salt crystals suspended within the supercritical water, the easier it is to separate the supercritical water from the salt crystals. Additionally, from a practical standpoint, if an inadequate amount of time is provided for the precipitation of salt out of the supercritical water, the salt crystals may be too small to efficiently separate from the supercritical water, whereby the device separating the supercritical water from the salt may be unable to perform its task. Thus, the amount of delay is dependent upon the rate of precipitation, the desired crystal size and the capabilities of the device separating the salt from the supercritical water. Delay may be achieved by employing a buffing tank or other portable holding area. It is understood that when a holding area is used, the holding area will be in a pressurized and/or heated vessel to maintain the supercritical state of the water.

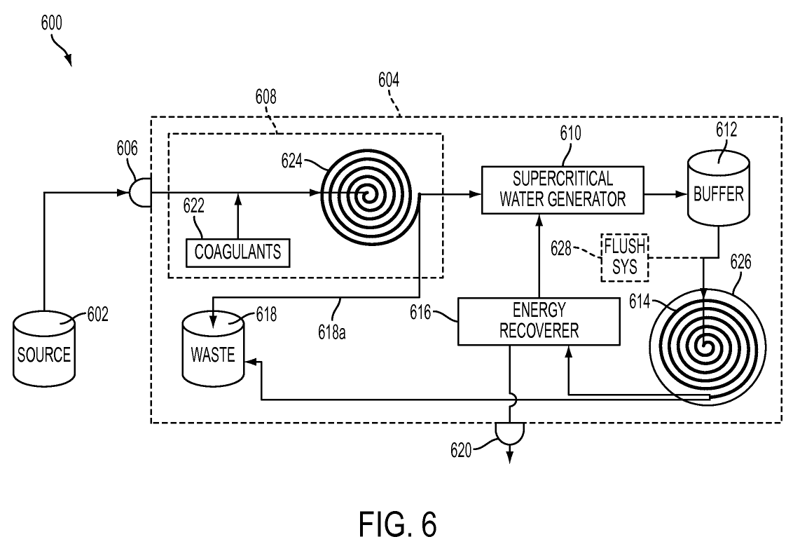

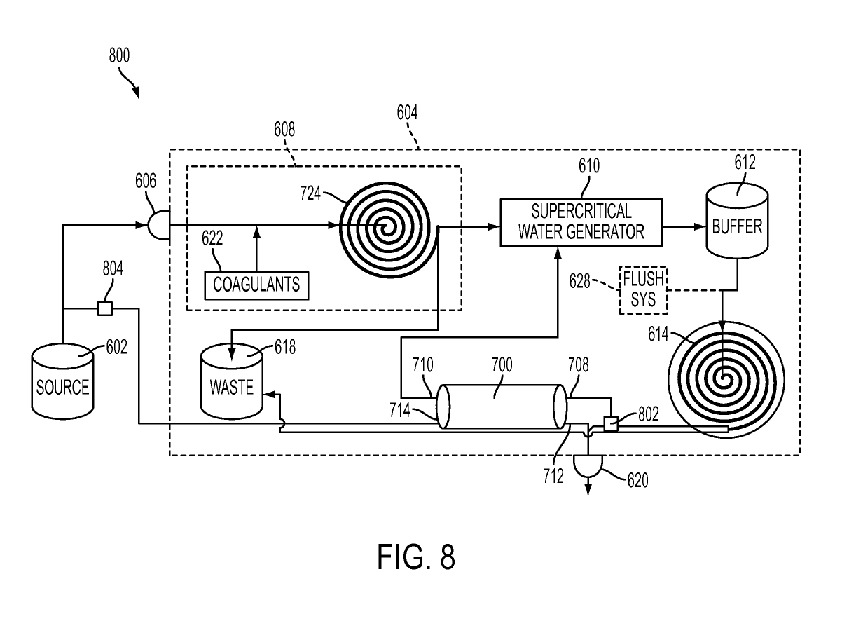

Regardless of whether the supercritical water is delayed (at 408), the supercritical water is next separated into effluent (or potable) water and waste water containing aggregated particles therein (e.g., salt). As should be appreciated by the discussion heretofore, the supercritical water is separated using spiral separator technology, such as the spiral separator shown in, and discussed in connection with, previous FIGS. 2 and 3, and to be discussed in FIGS. 6 and 8. The result is an output for effluent (or sterile, potable) water and an output for waste water containing aggregated particles therein.

Preferably, the resulting effluent water may contain approximately 1000 ppm salt to as little as 100 ppm salt. It is understood recovered effluent water may be put to different uses having different requirements. For example, if the recovered water is to be used for irrigation less than 1000 ppm would be acceptable, whereas if the use is for drinking water, 500 ppm is needed. Thus, the present system, as the skilled artisan will appreciate, is capable of generating effluent water well within federal and world standards for different applications. Additionally, the waste water is preferably stored for proper disposal or sent to another system to remove the aggregated salt particles suspended within the waste water.

Advantageously, the spiral separator allows the separation of neutrally buoyant particles from the salt water, whereby supercritical water with a temperature and/or a pressure at or about the critical temperature T_{c} and/or critical pressure p_{c}, respectively, may be used. As should be appreciated, the lower the temperature and the pressure of the supercritical water, the less energy is required to produce the supercritical water. Additionally, this further allows the spiral separator to efficiently remove salts which precipitate at a slow rate, whereby the spiral separator can remove much smaller salt crystals than a hydroclone, which depends on sedimentation.

Additionally, the use of a spiral separator for separation (at 406) advantageously produces waste water that is easily disposed of. Namely, in contrast with brine water of reverse osmosis, which contains high concentrations of salt dissolved therein, the waste water of the exemplary methods and systems merely contains salt suspended therein. As the skilled artisan will appreciate, the removal of suspensions from water is relatively easy and inexpensive compared to the removal of dissolved materials from water. The exemplary methods and systems discussed herein can also be used to process brine waste water, which, as discussed above, is difficult to dispose of in an environmentally friendly manner.

From the perspective of a zero liquid discharge (ZLD) target, the use of a spiral separator is advantageous. Namely, the goal of a ZLD target is to remove 100% of the salt within water. In the case of reverse osmosis, as the concentration of salt within the water increases, the efficiency of reverse osmosis desalination process decreases. The spiral separator, on the other hand, does not suffer from such a limitation, whereby the efficiency of spiral separator is not dependent upon the concentration of salt within the supercritical water (or at last not to the same degree as reverse osmosis).

After the supercritical water is separated (at 410), heat and/or pressure (collectively referred to as energy) are optionally recovered from the supercritical water (at 412). This recovered energy may then be used for the generation of supercritical water (at 406). This recovered energy advantageously reduces the amount of energy required to be expended for desalination. Naturally, as the efficiency of energy recovery (at 410) increases, the less external energy the exemplary methods and systems require, and the more competitive the exemplary methods and systems become with other desalination systems, such as reverse osmosis.

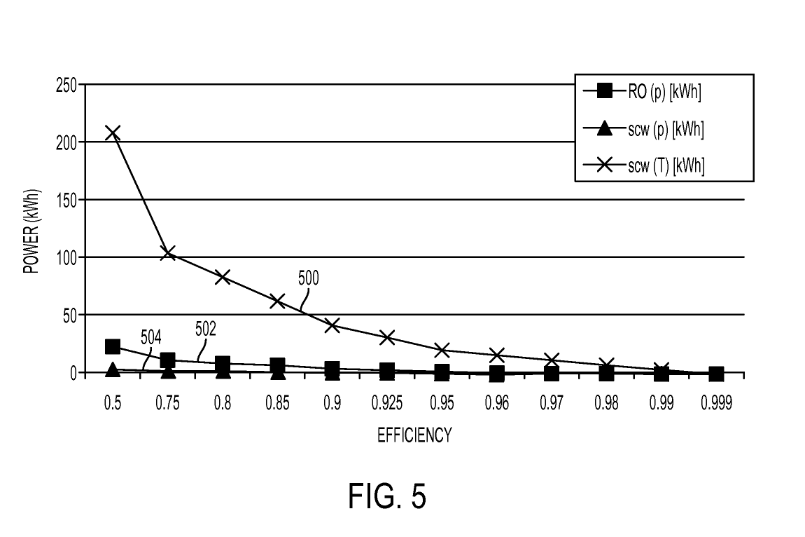

With reference to FIG. 5, a graph of the energy requirements for different desalination methods is illustrated. The graph shows the amount of power (in kilowatt hours) required to generate 1 m³ of desalinated water as a function of the energy recovery efficiency. Curve 500 corresponds to the amount of power required to heat supercritical water as a function of the efficiency of the heat recovery. Curve 502 corresponds to the amount of power required to pressurize water for reverse osmosis as a function of the efficiency of pressure recovery. Curve 504 corresponds to the amount of power required to pressurize supercritical water as a function of the efficiency of pressure recovery.

With reference to FIG. 6, an exemplary system 600 employing the exemplary method discussed above is illustrated. The system 600 includes source water 602 and a water desalination system 604. The water desalination system 604 includes an inlet 606, a pretreater 608, a supercritical water generator 610, a buffer tank 612, a spiral separator 614, an energy recoverer (e.g., pressure and/or heat) 616, a waste tank 618 and an outlet 620. The pretreater 608 includes coagulants 622, and spiral separator 624. As will be appreciated, the individual components of the system 600 align closely with the individual elements of the method 400 of FIG. 4. Consequently, the following discussion places emphasis on structure facilitating the elements of the method 400 of FIG. 4.

The source water 602 may be from an ocean, aquifer, storage tank, another system for processing water, or any other like source of water. Additionally, because the exemplary methods and systems of the present application are directed towards water desalination, the source water preferably contains particles, such as salts, therein. However, as discussed above, the systems and methods of the present application are equally amenable to uses other than water desalination.

The water desalination system 604 receives source water 602 via inlet 606. The water may, for example, be pumped to the water desalination system 604 from the above mentioned sources or other sources. The pretreater 608 then pretreats the water to remove suspensions and submicron organics as discussed at 404 of FIG. 4 above. Coagulants 622 are mixed with the source water 602 thereby causing suspensions in the source water to aggregate. Thereafter, the spiral separator 624 of the pretreater 608 removes the suspensions and submicron organisms from the source water. Preferably, the spiral separator supports the separation of neutrally buoyant particles, as described in U.S. patent application Ser. No. 11/936,729, incorporated herein by reference. As shown in FIG. 6, the waste water is stored to waste tank 618 where it can be processed as necessary or, for example, at least a position thereof may be reused in the supercritical water generator (e.g., via line 618a.). Alternatively, the waste water may be sent directly to a waste water processing system so as to remove any toxins or pollutants from the waste water and/or obtain salt for the waste water.

Thereafter, the pretreated water is converted to supercritical water within supercritical water generator 610 as discussed at 406 of FIG. 4. Namely, the water is both heated and pressurized above the critical temperature T_{c} and critical pressure Pc, respectively, necessary for reaching the supercritical state. The supercritical water generator 610, in at least one embodiment, includes flash or other heaters and pressure pumps to heat and pressurize the water, respectively. As discussed below, this process can also use energy recovered from the energy recoverer 616. For example, heat exchangers and pressure exchangers may be employed. Once the water achieves a supercritical state, salt dissolved within the water begins to precipitate out of the water to form salt crystals.

The supercritical water is then, in at least one embodiment, stored in a buffer tank 612 until the salt crystals achieve a desired size. The buffer tank serves to introduce the delay discussed at 408 of FIG. 4. By delaying the supercritical water, there is more time for the salt within the supercritical water to precipitate. The larger the salt crystals, the easier it is to separate them from the water. Thus, in one embodiment, buffer tank is a heated pressurized vessel. The skilled artisan will appreciate that because the buffer tank 612 is storing supercritical water, it needs to be structurally capable of handling the pressure and temperature of supercritical water. Additionally, notwithstanding that a buffer tank is being used to delay the supercritical water, other methods of delaying the supercritical water are equally amenable.

Once the supercritical water has been delayed for an amount of time, the water is separated from the salt using spiral separator 614 as discussed at 410 of FIG. 4. As discussed above, because the spiral separator is operating on supercritical water, it needs to be structurally capable of handling the pressure and temperature of supercritical water. One option for achieving this is placing a spiral separator into a standard Conflat flange system 626. To facilitate the flow of the supercritical water through the spiral separator 614, the spiral separator 614 preferably has a change of pressure between the input and the output, where the pressure at the input is greater than the pressure at the output. Naturally, the larger the change of pressure, the faster the supercritical water will flow through the spiral separator.

The spiral separator 614 may optionally include a flushing system 628 to remove any scale build-up (i.e., salt crystals that have built-up on the channel walls of the spiral separator). The flushing system simply flushes the spiral separator with fresh water. This may, for example, be automated at regular intervals. Generally, the flushing system only needs to be used after the flow through the spiral separator 614 stops. Namely, the flow rate through the spiral separator should generally be sufficiently high to avoid scale build-up.

After separation, the effluent water is directed towards the energy recoverer 616, wherein pressure and/or heat are recovered and used by the supercritical water generator 610 to generate supercritical water. As should be appreciated, this mirrors the discussion at 412 of FIG. 4. Energy recovery may be accomplished through the use of any number of commercial heat exchangers and/or pressure exchangers. It should also be appreciated that energy can also be recovered from the waste water. However, the salt should be removed from the waste water before recovering energy from the waste water. This follows because once energy is recovered from the waste water, the waste water loses supercritical status, whereby the salt that was suspended therein will dissolve into the water and create brine water.

With respect to recovering heat, the heating of water to the supercritical phase and back is a reversible process unlike distillation. Namely, the supercritical water isn't doing any work because the heating is done at effectively a constant volume. Consequently, a very good heat exchanger could, in principle, extract heat from the supercritical water after separation (at 408) and preheat the incoming water. However, this is a daunting task because a regenerative heat exchanger will have to be efficient to levels of 50% energy recovery. Regardless of this challenge, there is no thermodynamic reason why regenerative heat exchangers cannot be made 100% efficient.

After the energy is extracted from the effluent water, the potable water is output from desalination system 604 via outlet 620. The waste water may, as shown in FIG. 6, be sent to storage tank 618, where it can be processed as necessary. As with the waste water of spiral separator 624 of pretreater 608, alternatively, the waste water 618 may be sent directly to a waste water processing system so as to remove any toxins or pollutants from the waste water. For example, the waste water may be sent to a waste water processing system to remove salt suspended therein.

Common types of heat exchangers may be used. One example is a spiral heat exchanger (SHE) wherein a first spiral channel is nested with a second spiral channel. Hot water flows through the first spiral channel and water to be heated flows through the second spiral channel. The spiral heat exchanger is often used in the heating of fluids which contain solids that have a tendency to foul the inside of the heat exchanger. The device has low pressure drop and has a “self cleaning” mechanism, whereby fouled surfaces cause a localized increase in fluid velocity, thus increasing the drag (or fluid friction) on the fouled surface, thus helping to dislodge the blockage and keep the heat exchanger clean.

With respect to recovering pressure, recent advances in the development of pressure exchangers can be used to implement the present device. For example, Energy Recovery, Inc., for example, has an efficient, energy saving, energy recovery solution: the PX Pressure Exchanger® (PX). The PX uses the principle of positive displacement and isobaric chambers to achieve extremely efficient transfer of energy from a high-pressure waste stream, such as the brine stream from a reverse osmosis desalination unit, to a low-pressure incoming feed stream. The PX device is highly efficient, up to 98%, whereby virtually no energy is lost in the transfer.

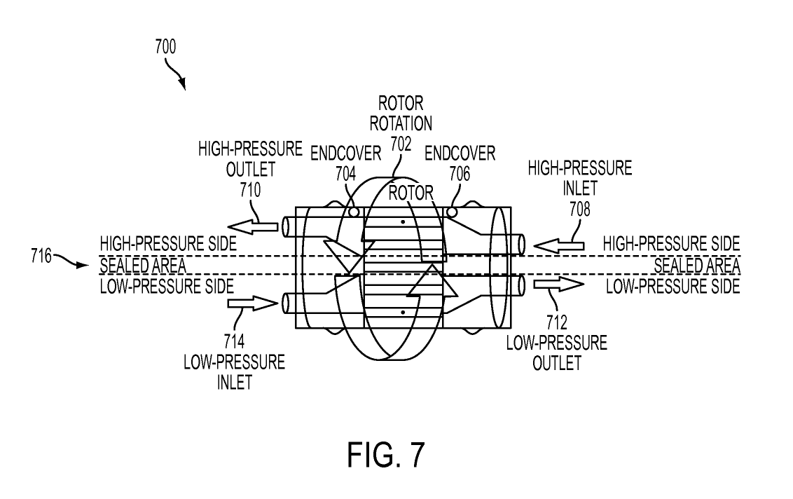

As illustrated in FIG. 7, PX device 700 includes a rotor 702, a first end-cover 704, a second end-cover 706, a high pressure side (defined by a first high pressure inlet 808 and a second high pressure inlet 710), a low pressure side (defined by a first low pressure inlet 712, a second low pressure inlet 714), and a sealed area 716, which separates the high and low pressure sides from each other. Rotor 702 is a cylindrical rotor with long narrow ducts. The rotor spins inside a sleeve between end covers 704, 706 with port openings for inlet streams. Pressure energy is transferred directly from the high-pressure stream of inlet 708 to the low-pressure incoming feed stream at inlet 710. The rotor self-adjusts its speed to keep the interface between the streams within the rotor and limit mixing. The low pressure side of the rotor fills with water while the high-pressure side the water. The motion of the rotor is similar to that of a Gatling machine gun firing high pressure bullets from a supply of low-pressure seawater.

Turning now to FIG. 8, set out is a system embodiment 800 similar to that of FIG. 6, which incorporates the PX device 700 of FIG. 7 as the energy recoverer 616. In this design a waste stream and effluent stream exit spiral separator 614. The waste stream is directed to the waste storage tank 618, as before. However, at least a portion of the effluent stream is directed to high pressure inlet 708 via flow director 802 which is designed to discharge all or some of the effluent to output 620 with the remainder going to inlet 708. Additionally, a flow director 804 allows at least a portion of the source water 602 to be directed to low pressure inlet 714. The internal operation of PX device 700 then causes the energy (in the form of heat and/or pressure) of the effluent stream to be absorbed by the diverted portion of source water 602. The portion of source water going through PX device 700 is output via first outlet 710 to supercritical water generator 610, whereby at least the portion of the source water going through the PX device 700 has been pre-heated and/or pre-pressurized prior to being supplied to supercritical water generator 610. The portion of the effluent that travels through PX device 700 is then passed out of outlet 712 and out of the system 604 at outlet 620.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method for treatment of water comprising:
receiving source water having particles therein;
generating supercritical water from the source water; and
separating the supercritical water into effluent water and waste water having aggregated particles, wherein the supercritical water is separated using a spiral separator.

2. The method of claim 1, further comprising:
pre-treating the source water to remove suspensions and/or sub-micron organics.

3. The method of claim 2, wherein the pre-treating of the source water comprises:
mixing the source water with a coagulant material; and
separating the source water from the suspensions and/or sub-micron organics using a spiral separator.

4. The method of claim 1, wherein the separating of supercritical water comprises:
pressurizing the source water to or beyond a critical pressure; and
heating the source water to or beyond a critical temperature.

5. The method of claim 1, further comprising:
recovering energy from the effluent water and/or the waste water, wherein the energy includes heat and/or pressure.

6. The method of claim 5, wherein the supercritical water is generated using the energy recovered from the effluent water and/or the waste water.

7. The method of claim 1, further comprising:
delaying the separation of the supercritical water until the particles therein begin to precipitate out and achieve a size large enough for separation.

8. The method according to claim 1, wherein the pressurizing and heating increase a precipitation of particles out of the fluid, the particles being salt particles.

9. The method according to claim 8, wherein the pressurizing and heating includes applying varying combinations of different amounts of pressure and heat to precipitate out different types of salt particles.

10. The method according to claim 8, wherein the precipitation of selected salts is achieved in a single step.

11. The method according to claim 8, wherein the precipitation of selected salts is achieved in multiple consecutive steps.

12. A system for the treatment of water comprising:
an inlet operative to receive source water having particles therein;
a supercritical water generator operative to generate super critical water from the source water;
a spiral separator operative to separate the supercritical water into effluent water and waste water having aggregated particles therein; and
an outlet operative to provide a path for the effluent water.

13. The system of claim 12, wherein the supercritical water generator pressurizes and heats the source water, wherein the source water is pressurized to or above a critical pressure, wherein the source water is heated to or above a critical temperature.

14. The system of claim 13, wherein a ratio of different particle types in the waste water is adjusted by varying a temperature to which the source water is heated and/or by varying a pressure to which the source water is pressurized.

15. The system of claim 12, further comprising:
a buffer tank operative to hold the supercritical water generated by the supercritical water generator until the particles therein begin to precipitate out and achieve a size large enough for separation.

16. The system of claim 12, further comprising:
an energy recoverer operative to recover heat and/or pressure from the effluent water and/or the waste water.

17. The system of claim 15, wherein the supercritical water generator uses recovered heat and/or pressure from the energy recoverer.

18. The system of claim 12, further comprising:
a pretreater operative to remove suspensions and/or sub-micron organics from the source water.

19. The system of claim 18, wherein the pretreater mixes a coagulant with the source water.

20. A system for separation of particles from supercritical water, the system comprising:
an inlet to receive at least a portion of the supercritical water containing the particles;
a spiral channel within which the supercritical water flows in a manner such that the particles flow in a tubular band offset from a center of the channel, wherein the channel is pressurized to at least 22.1 MPa and the supercritical water is heated to at least 647° K;
a first outlet for the supercritical water within which the tubular band flows; and,
a second outlet for the remaining supercritical water.
